(19) United States
(12) Patent Application Publication
(10) Pub. No.: US 2025/0173813 A1
(43) Pub. Date: May 29, 2025

(54) IMAGE PROCESSING METHOD AND DEVICE, APPARATUS AND STORAGE MEDIUM

(71) Applicant: Beijing Zitiao Network Technology Co., Ltd., Beijing (CN)

(72) Inventors: Ziyang CHENG, Beijing (CN); Siyu ZHOU, Beijing (CN)

(21) Appl. No.: 18/841,351

(22) PCT Filed: Feb. 16, 2023
(86) PCT No.: PCT/CN2023/076357

§ 371 Date: Aug. 23, 2024

(30) Foreign Application Priority Data
Feb. 24, 2022 (CN) 202210173342.8

(51) Int. Cl. G06T 3/00; G06T 5/50; G06T 5/60

(52) U.S. Cl. CPC G06T 3/00; G06T 5/50; G06T 5/60; G06T 2207/20084

(57) ABSTRACT

An image processing method and device, an electronic apparatus and a storage medium are disclosed. The image processing method includes: inputting an original image into a generator of a generative adversarial network to obtain an intermediate image and first pixel transformation information; and performing pixel transformation on the intermediate image according to the first pixel transformation information to obtain a target image.

The present application claims priority of the Chinese Patent Applications No. 202210173342.8 filed on Feb. 24, 2022, the content of which is incorporated as a part of the present application.

### TECHNICAL FIELD

The present disclosure relates to the technical field of image processing, and, for example, relates to an image processing method and apparatus, a device and a storage medium.

### BACKGROUND

An image application (APP) has many effect playing methods based on image algorithms, and some effect playing methods will change a face and facial features, such as face thinning, becoming a child and getting fat, etc. When a deformation difference between an original image and an effect image is too large, for example, when processing an image including a contour of a face edge and sizes and positions of the facial features, a final result image will have ghosts at the face edge and the positions of the facial features. This is because a deformation extent of the effect is too large, and a traditional network cannot learn such a large deformation.

### SUMMARY

The present disclosure provides an image processing method and device, an apparatus and a storage medium, so as to implement the processing on a large deformation of a face image, and overcome the problem of ghosts caused by large deformation, thereby improving the effect of face image deformation.

An embodiment of the present disclosure provides an image processing method, which includes:
inputting an original image into a generator of a generative adversarial network to obtain an intermediate image and first pixel transformation information; and
performing pixel transformation on the intermediate image according to the first pixel transformation information to obtain a target image.

An embodiment of the present disclosure further provides an image processing device, which includes:
a first pixel transformation information acquisition module configured to input an original image into a generator of a generative adversarial network to obtain an intermediate image and first pixel transformation information; and
a pixel transformation module configured to perform pixel transformation on the intermediate image according to the first pixel transformation information to obtain a target image.

An embodiment of the present disclosure further provides an electronic apparatus, which includes:
at least one processing device; and
a storage apparatus configured to store at least one program,
the at least one program, when executed by the at least one processing device,
causing the at least one processing device to implement the image processing method as described by the embodiments of the present disclosure.

An embodiment of the present disclosure further provides a computer-readable medium, on which a computer program is stored, wherein the computer program, when executed by a processing device, implements the image processing method as described by the embodiments of the present disclosure.

### BRIEF DESCRIPTION OF DRAWINGS

FIG. 1 is a flowchart of an image processing method in an embodiment of the present disclosure;

FIG. 2 is an exemplary diagram of performing optical flow transformation on an intermediate image in an embodiment of the present disclosure;

FIG. 3 is an exemplary diagram of training a generative adversarial network in an embodiment of the present disclosure;

FIG. 4 is an exemplary diagram of a network structure of a generator in an embodiment of the present disclosure;

FIG. 5 is a structural schematic diagram of an image processing device in an embodiment of the present disclosure; and

FIG. 6 is a structural schematic diagram of an electronic apparatus in an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be implemented in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps described in the method embodiments of the present disclosure may be performed in a different order and/or in parallel. Furthermore, method embodiments may include additional steps and/or omit performing the illustrated steps. The scope of the present disclosure is not limited in this respect.

As used herein, the term “including” and its variants are open-ended including, that is, “including but not limited to”. The term “based on” is “at least partially based on”. The term “one embodiment” refers to “at least one embodiment”; the term “another embodiment” refers to “at least one other embodiment”; the term “some embodiments” refers to “at least some embodiments”. Related definitions of other terms will be given in the following description.

It should be noted that the concepts of “first” and “second” mentioned in the present disclosure are only used to distinguish different devices, modules or units, and are not used to limit the order or interdependence of the functions performed by these devices, modules or units.

It should be noted that the modifications of “a” and “a plurality” mentioned in the present disclosure are schematic rather than limiting, and those skilled in the art should understand that unless the context clearly indicates otherwise, they should be understood as “one or more”.

The names of messages or information exchanged between multiple devices in the embodiment of the present disclosure are only used for illustrative purposes, and are not used to limit the scope of these messages or information.

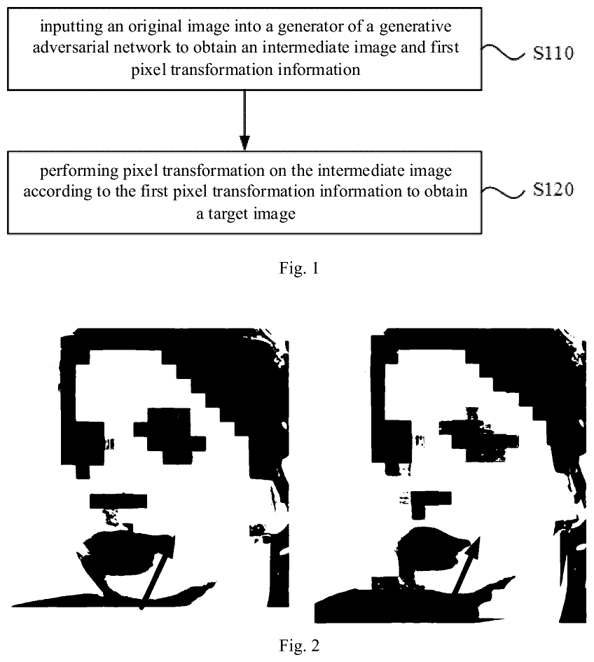

FIG. 1 is a flowchart of an image processing method provided by an embodiment of the present disclosure. The present embodiment may be applied to a case of deformation processing on a face image. This method may be executed by an image processing device, the device may be composed of hardware and/or software, and can generally be integrated into an apparatus with an image processing function which may be an electronic apparatus such as a server, a mobile terminal or a server cluster. As illustrated by FIG. 1, the method includes the following steps.

S110: inputting an original image into a generator of a generative adversarial network to obtain an intermediate image and first pixel transformation information.

The original image can be understood as an image which includes a human face and is to be deformed, the image may be collected by a user through a camera of a mobile terminal or acquired from a local database or a server database. The generative adversarial network may be a trained pix2pix generative adversarial neural network, and an output of the generator is multi-channel data. In the present embodiment, the output of the generator includes image data and pixel transformation information, where the image data is three-channel data and the pixel transformation information is 1-channel or 2-channel data, and a number of output channels of the generator may be adjusted according to actual requirements.

The first pixel transformation information may be optical flow transformation information, affine transformation information and/or perspective transformation information. If it is optical flow transformation information, the first pixel transformation information is 2-channel data, each channel is represented by a matrix of image size, and these two channels represent position information (X, Y) of a pixel point. If it is affine transformation information, the first pixel transformation information is 1-channel data, which is a vector including six elements. If it is perspective transformation information, the first pixel transformation information is 1-channel data, which channel data is a 3*3 matrix or a vector including nine elements. In the present embodiment, the first pixel transformation information may be different transformation information, and different types of deformation processing may be implemented on the face image, thereby improving the diversity of deformation.

S120: performing pixel transformation on the intermediate image according to the first pixel transformation information to obtain a target image.

The first pixel transformation information includes optical flow transformation information, affine transformation information or perspective transformation information, and the pixel transformation methods are different for different transformation information.

Exemplarily, if the first pixel transformation information is optical flow transformation information, the optical flow transformation information is represented by an optical flow transformation matrix, and each element in the optical flow transformation matrix characterizes a position offset between a pixel corresponding to the element in the intermediate image and a pixel corresponding to the element in the target image. The pixel transformation on the intermediate image according to the first pixel transformation information to obtain a target image may be performed by: traversing elements of the optical flow transformation matrix, and according to the position offset of an element as traversed and current position information of a pixel corresponding to the element in the intermediate image, determining target position information of the pixel; acquiring a current pixel value corresponding to the current position information and a target pixel value corresponding to the target position information in the intermediate image; and replacing the current pixel value with the target pixel value to obtain the target image.

Each element in the optical flow transformation matrix may be expressed as (Δx, Δy), representing an offset of two position information. The according to the position offset of an element as traversed and current position information of a pixel corresponding to the element in the intermediate image, determining target position information of the pixel may be performed by: accumulating current position information and the position offset to obtain target position information, where an abscissa of a current position is accumulated with an abscissa offset Δx to obtain an abscissa of a target position, and an ordinate of the current position is accumulated with an ordinate offset Δy to obtain an ordinate of the target position.

Exemplarily, assuming that the traversed current position information is (x1, y1), and the position offset at the current position is (Δx, Δy), then the target position information is (x1+Δx, y1+Δy), then a pixel value of a pixel point at the current position (x1, y1) in the intermediate image is replaced by a pixel value of a pixel point at a position (x1+Δx, y1+Δy) in the intermediate image; and the above-mentioned operations are performed on each pixel point in the intermediate image so as to obtain the target image. Exemplarily, FIG. 2 is an exemplary diagram of performing optical flow transformation on an intermediate image in the present embodiment. As illustrated by FIG. 2, the intermediate image is shown on a left side and the target image is show in on a right side in FIG. 2. Corners of the mouth in the left image after optical flow transformation are turned into faces in the right image. According to the embodiment of the present disclosure, pixel transformation is performed on the intermediate image through the optical flow transformation information, so that the clarity of the target image may be improved.

Optionally, the affine transformation information is a matrix with a first predetermined size; and a process of performing the pixel transformation on the intermediate image according to the first pixel transformation information to obtain a target image may include: for each pixel in the intermediate image, left-multiplying the current position information of the pixel by the first pixel transformation information to obtain the target position information of the pixel; and transferring the pixel value of the pixel to a position corresponding to the target position information to obtain the target image.

If the first pixel transformation information is affine transformation information, the first predetermined size may be 3*3. The affine transformation information may be expressed as

$$[ \begin{matrix}a & b & c \\ d & e & f \\ 0 & 0 & 1\end{matrix} ] ,$$

and the perspective transformation information may be expressed as

$$[ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] .$$

As can be seen from the above, for the affine transformation matrix, the third row is a known quantity, thus affine transformation information outputted by the generator is a vector including six elements; for the perspective transformation matrix, each element is an unknown quantity, thus the perspective transformation information outputted by the generator is a vector including nine elements or a 3*3 matrix.

In the present embodiment, for each pixel of the intermediate image, it is assumed that the position information of the current pixel point is expressed as (x, y) and the target position information of the current pixel is expressed as (x1, y1). Assuming that the first pixel transformation information is affine transformation information, the performing pixel transformation on the intermediate image according to the first pixel transformation information may be expressed as:

$$[ \begin{matrix}x 1 \\ y 1 \\ 1\end{matrix} ] = [ \begin{matrix}a & b & c \\ d & e & f \\ 0 & 0 & 1\end{matrix} ] [ \begin{matrix}x \\ y \\ 1\end{matrix} ] ,$$

that is, current position information of the pixel point is left multiplied by the affine transformation information to obtain target position information of the pixel. The target position information of the pixel point is obtained, the pixel value of the pixel point is transferred to the position corresponding to the target position information, and the above-mentioned operations are performed on each pixel point in the intermediate image to implement the affine transformation of each pixel point, so as to obtain the target image. According to the embodiment of the present disclosure, pixel transformation is performed on the intermediate image through the affine transformation information, so that the clarity of the target image may be improved.

Optionally, the perspective transformation information is a matrix with a second predetermined size. The pixel transformation on the intermediate image according to the first pixel transformation information to obtain a target image may be performed by: for each pixel in the intermediate image, left-multiplying the current position information of the pixel by the first pixel transformation information to obtain the target position information of the pixel; and transferring the pixel value of the pixel to a position corresponding to the target position information to obtain the target image.

If the first pixel transformation information is perspective transformation information, the second predetermined size is 3*3. The performing pixel transformation on the intermediate image according to the first pixel transformation information may be expressed as:

$$[ \begin{matrix}x 1 \\ y 1 \\ 1\end{matrix} ] = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}x \\ y \\ 1\end{matrix} ] ,$$

that is, current position information of the pixel point is left multiplied by the perspective transformation information to obtain target position information of the pixel. The target position information of the pixel point is obtained, the pixel value of the pixel point is transferred to the position corresponding to the target position information, and the above-mentioned operations are performed on each pixel point in the intermediate image to implement the perspective transformation of each pixel point, so as to obtain the target image. According to the embodiment of the present disclosure, pixel transformation is performed on the intermediate image through the perspective transformation information, so that the clarity of the target image may be improved.

Optionally, the generative adversarial network further includes a discriminator; and the generative adversarial network is trained by: acquiring an original image sample and a result image sample corresponding to the original image sample; inputting the original image sample into the generator to obtain an intermediate image sample and second pixel transformation information; performing pixel transformation on the intermediate image sample according to the second pixel transformation information to obtain a generated graph; and performing alternating iterative training on the generator and the discriminator based on the generated graph, the original image sample and the result image sample.

The original image sample may be an image including a human face without being subjected to deformation processing, and the result image sample can be understood as a high-quality image subjected to deformation processing corresponding to the original image sample, that is, the result image sample is an image obtained by deformation processing on the original image sample. In the present embodiment, the way of performing pixel transformation on the intermediate image sample according to the second pixel transformation information is the same as the way of performing pixel transformation on the intermediate image according to the first pixel transformation information in the above embodiment, and the details are omitted here.

Exemplarily, the performing alternating iterative training on the generator and the discriminator can be understood as that the discriminator is trained one time, the generator is trained one time after the discriminator is trained, the discriminator is trained one time after the generator is trained, and so on, until a training completion condition is met. In the present embodiment, the alternating iterative training is performed on the generator and the discriminator based on the generated graph, the original image sample and the result image sample, so that the accuracy of the generator in generating the intermediate image and the pixel transformation information can be improved.

In the present embodiment, a process of performing the alternating iterative training on the generator and the discriminator based on the generated graph, the original image sample and the result image sample may include: combining the generated graph and the original image sample into a negative sample pair, and combining the result image sample and the original image sample into a positive sample pair; inputting the positive sample pair into the discriminator to obtain a first discriminant result; inputting the negative sample pair into the discriminator to obtain a second discriminant result; determining a first loss function based on the first discriminant result and the second discriminant result; determining a second loss function according to the generated graph and the result image sample; linearly superposing the first loss function and the second loss function to obtain a target loss function; and based on the target loss function, performing alternating iterative training on the generator and the discriminator based on the target loss function.

The first discriminant result and the second discriminant result may be values between 0 and 1, which are used to characterize the matching degree between sample pairs. For the positive sample pair, its true discriminant result is 0, and for the negative sample pair, its true discriminant result is 1. Exemplarily, the determining a first loss function based on the first discriminant result and the second discriminant result may be performed by: calculating a first difference value between the first discriminant result and the true discriminant result corresponding to the positive sample pair, calculating a second difference value between the second discriminant result and the true discriminant result corresponding to the negative sample pair, and solving logarithms of the first difference and the second difference respectively and then accumulating to obtain the first loss function.

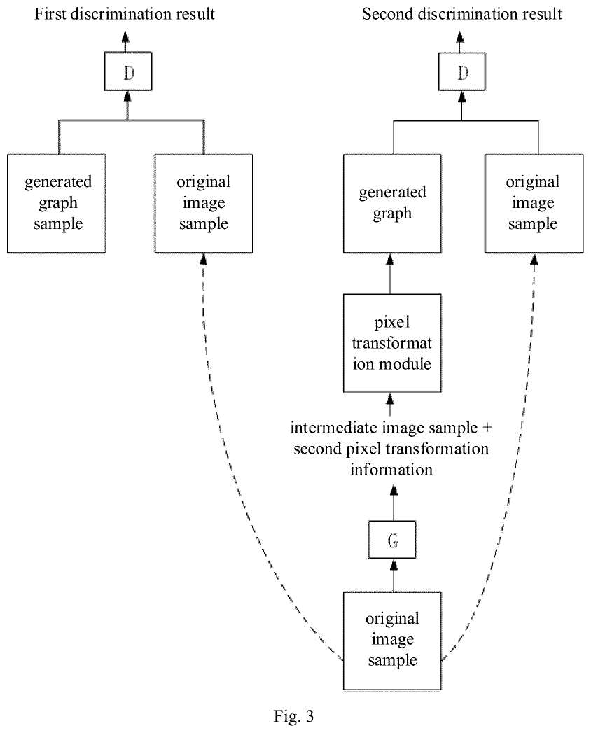

The second loss function may be determined by a difference value between the generated map and the result image sample. Exemplarily, all original image samples are inputted into the generative adversarial network to obtain a target loss function, and the target loss function performs back propagation to adjust parameters of the discriminator; based on the discriminator with adjusted parameters, all original image samples are inputted into the generative adversarial network to obtain a target loss function, the target loss function performs back propagation to adjust parameters of the generator; then, based on the generator with adjusted parameters, all original image samples are inputted into the generative adversarial network to obtain a target loss function, and the target loss function performs back propagation to adjust the parameters of the generator. In this way, alternating iterative training is performed on the generator and the discriminator until a training termination condition is met. Exemplarily, FIG. 3 is an exemplary diagram of training a generative adversarial network in the present embodiment. As illustrated by FIG. 3, an original image sample is inputted into a generator G to obtain an intermediate image sample and second pixel transformation information, the intermediate image sample and the second pixel transformation information are inputted into a pixel transformation module to obtain a generated graph, the generated graph and the original image sample are pairwise inputted into a discriminator D to obtain a second discriminant result, the original image sample and a result image sample are pairwise inputted into the discriminator D to obtain a first discriminant result, and a first loss function is determined based on the first discriminant result and the second discriminant result; a second loss function is determined according to the generated graph and the result image sample; the first loss function and the second loss function are linearly superimposed to obtain a target loss function, and alternating iterative training is performed on the generator and discriminator based on the target loss function. In the present embodiment, the performing alternating iterative training on the generator and discriminator based on the target loss function is used to constrain a deviation between the generated graph and the result image sample, thus improving the accuracy of the generator.

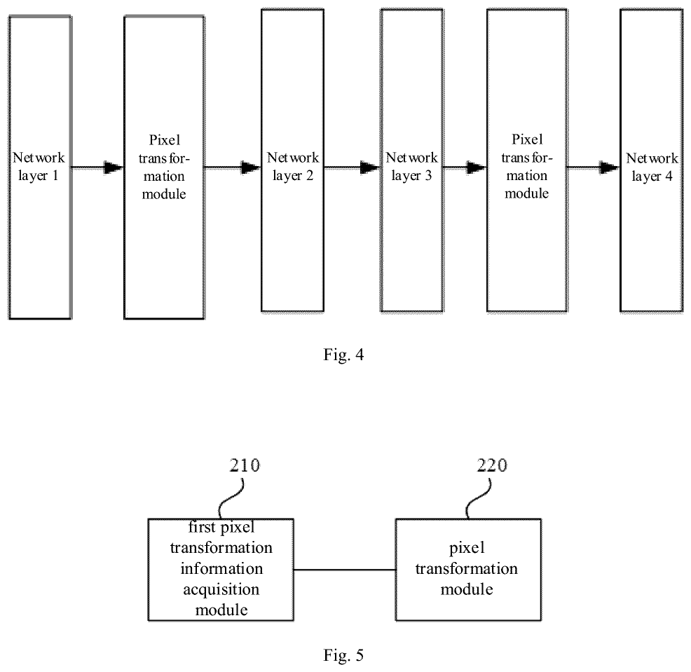

Optionally, the generator includes a plurality of network layers and at least one pixel transformation module; the pixel transformation module is disposed between two network layers; the forward adjacent network layer of the pixel transformation module outputs a feature map and third pixel transformation information; the pixel transformation module is configured to perform pixel transformation on the feature map according to the third pixel transformation information and output the transformed feature map; and the transformed feature map is inputted to the backward adjacent network layer of the pixel transformation module. Exemplarily, FIG. 4 is an exemplary diagram of a network structure of a generator in the present embodiment. As illustrated by FIG. 4, the generator includes 4 network layers, where one pixel transformation module is disposed between the network layer 1 and the network layer 2, and one pixel transformation module is disposed between the network layer 3 and the network layer 4. As for the first pixel transformation module, it is used to perform pixel transformation on the feature map outputted by the network layer 1 according to the third pixel transformation information outputted by the network layer 1, and the transformed feature map is inputted into the network layer 2. As for the second pixel transformation module, it is used to perform pixel transformation on the feature map outputted by the network layer 3 according to the third pixel transformation information outputted by the network layer 3, and the transformed feature map is inputted into the network layer 4. In the present embodiment, the pixel transformation modules are embedded between the network layers of the generator, and deformation processing of a face image is implemented in the neural network, so that a workload can be reduced.

According to the technical solution of the embodiment of the present disclosure, the original image is inputted into the generator of the generative adversarial network to obtain the intermediate image and first pixel transformation information; and pixel transformation is performed on the intermediate image according to the first pixel transformation information to obtain the target image. According to the image processing method provided by the embodiment of the present disclosure, pixel transformation is performed on the intermediate image by using the first pixel-transformed information outputted by the generative adversarial network to obtain the target image, so that the processing on the large deformation of the image is implemented, and the problem of ghosts caused by deformation may be overcome, thereby improving the effect of image deformation.

FIG. 5 is a structural schematic diagram of an image processing device provided by an embodiment of the present disclosure. As illustrated by FIG. 5, the device includes the following modules:
a first pixel transformation information acquisition module 210 configured to input an original image into a generator of a generative adversarial network to obtain an intermediate image and first pixel transformation information; and
a pixel transformation module 220 configured to perform pixel transformation on the intermediate image according to the first pixel transformation information to obtain a target image.

Optionally, the first pixel transformation information includes optical flow transformation information, affine transformation information and/or perspective transformation information.

Optionally, the optical flow transformation information is represented by an optical flow transformation matrix, and each element in the optical flow transformation matrix characterizes a position offset between a pixel corresponding to the element in the intermediate image and a pixel corresponding to the element in the target image;

The pixel transformation module 220 is further configured to:
traverse elements of the optical flow transformation matrix, and according to the position offset of an element as traversed and current position information of a pixel corresponding to the element in the intermediate image, determine target position information of the pixel;
acquire a current pixel value corresponding to the current position information and a target pixel value corresponding to the target position information in the intermediate image; and
replace the current pixel value with the target pixel value to obtain the target image.

Optionally, the affine transformation information is a matrix with a first predetermined size, where the pixel transformation module 220 is further configured to:
for each pixel in the intermediate image, left-multiply the current position information of the pixel by the first pixel transformation information to obtain the target position information of the pixel; and,
transfer the pixel value of the pixel to a position corresponding to the target position information to obtain the target image.

Optionally, the perspective transformation information is a matrix with a second predetermined size,

The pixel transformation module 220 is further configured to:
for each pixel in the intermediate image, left-multiply the current position information of the pixel by the first pixel transformation information to obtain the target position information of the pixel; and,
transfer the pixel value of the pixel to a position corresponding to the target position information to obtain the target image.

Optionally, the generative adversarial network further includes a discriminator; and the apparatus further includes: a generative adversarial network training module configured to:
acquire an original image sample and a result image sample corresponding to the original image sample;
input the original image sample into the generator to obtain an intermediate image sample and second pixel transformation information;
perform pixel transformation on the intermediate image sample according to the second pixel transformation information to obtain a generated graph; and
perform alternating iterative training on the generator and the discriminator based on the generated graph, the original image sample and the result image sample.

The generative adversarial network training module is further configured to:
combine the generated graph and the original image sample into a negative sample pair, and combine the result image sample and the original image sample into a positive sample pair;
input the positive sample pair into the discriminator to obtain a first discriminant result, and input the negative sample pair into the discriminator to obtain a second discriminant result;
determine a first loss function based on the first discriminant result and the second discriminant result; and
determine a second loss function according to the generated graph and the result image sample;
linearly superpose the first loss function and the second loss function to obtain a target loss function; and
perform alternating iterative training on the generator and the discriminator based on the target loss function.

The generator includes network layers and a pixel transformation module; the pixel transformation module is disposed between two network layers; the forward adjacent network layer of the pixel transformation module outputs a feature map and third pixel transformation information; the pixel transformation module is configured to perform pixel transformation on the feature map according to the third pixel transformation information and output the transformed feature map; and the transformed feature map is inputted to the backward adjacent network layer of the pixel transformation module.

The device can execute the methods provided by all the aforementioned embodiments of the present disclosure, and has corresponding functional modules and beneficial effects. For technical details that are not described in detail in the present embodiment, please refer to the methods provided by all the previous embodiments of the present disclosure.

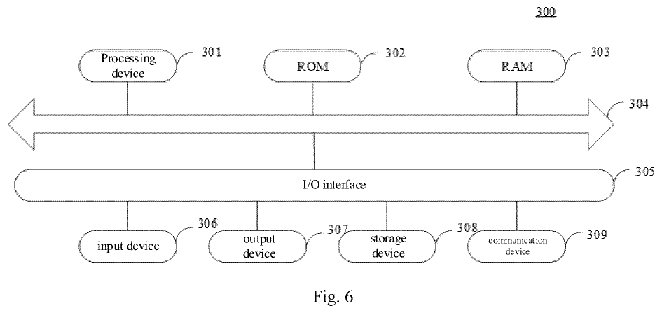

Hereinafter, referring to FIG. 6, which shows a structural schematic diagram of an electronic apparatus 300 suitable for implementing an embodiment of the present disclosure. The electronic apparatus in the embodiment of the present disclosure may include, but are not limited to, mobile terminals such as mobile phones, notebook computers, digital broadcast receivers, PDA (Personal Digital Assistant), PAD (Tablet Computer), PMP (Portable Multimedia Player), vehicle-mounted terminals (such as vehicle-mounted navigation terminals), and fixed terminals such as digital TV, desktop computers, or various forms of servers, such as independent servers or server clusters. The electronic apparatus shown in FIG. 6 is only an example, and should not bring any limitation to the function and application scope of the embodiment of the present disclosure.

As illustrated by FIG. 6, the electronic apparatus 300 may include a processing device (such as a central processing unit, a graphics processor, etc.) 301, which may perform various appropriate actions and processes according to a program stored in a read-only storage device (ROM) 302 or a program loaded from a storage device 305 into a random access storage device (RAM) 303. In the RAM 303, various programs and data required for the operation of the electronic apparatus 300 are also stored. The processing device 301, the ROM 302 and the RAM 303 are connected to each other through a bus 304. An input/output (I/O) interface 305 is also connected to the bus 304.

Generally, the following devices can be connected to the I/O interface 305: an input device 306 including, for example, a touch screen, a touch pad, a keyboard, a mouse, a camera, a microphone, an accelerometer, a gyroscope, etc.; an output device 307 including, for example, a liquid crystal display (LCD), a speaker, a vibrator, etc.; a storage device 308 such as a magnetic tape, a hard disk, etc.; and a communication device 309. The communication device 309 may allow the electronic apparatus 300 to perform wireless or wired communication with other devices to exchange data. Although FIG. 5 shows an electronic apparatus 300 with various devices, it should be understood that it is not required to implement or have all the devices shown. More or fewer devices may alternatively be implemented or provided.

In particular, according to an embodiment of the present disclosure, the process described above with reference to the flowchart can be implemented as a computer software program. For example, an embodiment of the present disclosure includes a computer program product, which includes a computer program carried on a computer-readable medium, and the computer program contains program code for executing a word recommendation method. In such an embodiment, the computer program can be downloaded and installed from the network through the communication device 309, or installed from the storage device 305, or installed from the ROM 302. When the computer program is executed by the processing device 301, the above functions defined in the method of the embodiment of the present disclosure are performed.

It should be noted that the computer-readable medium mentioned above in the present disclosure can be a computer-readable signal medium or a computer-readable storage medium or any combination of the two. The computer-readable storage medium can be, for example, but not limited to, an electrical, magnetic, optical, electromagnetic, infrared, or semiconductor system, device or apparatus, or a combination of any of the above. More specific examples of computer-readable storage media may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium can be any tangible medium containing or storing a program, which can be used by or in combination with an instruction execution system, device or apparatus. In the present disclosure, a computer-readable signal medium may include a data signal propagated in baseband or as part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, device or apparatus. The program code contained in the computer-readable medium can be transmitted by any suitable medium, including but not limited to: wires, optical cables, RF (radio frequency) and the like, or any suitable combination of the above.

In some embodiments, the client and the server can communicate by using any currently known or future developed network protocol such as HTTP (Hyper Text Transfer Protocol), and can be interconnected with digital data communication in any form or medium (for example, communication network). Examples of communication networks include a local area network (“LAN”), a wide area network (“WAN”), the Internet (for example, the Internet) and end-to-end networks (for example, ad hoc end-to-end networks), as well as any currently known or future developed networks.

The computer-readable medium may be included in the electronic apparatus; or it can exist alone without being assembled into the electronic equipment.

The computer-readable medium carries one or more programs, which, when executed by the electronic apparatus, cause the electronic apparatus to: acquire the first original 3D information of the 3D material to be rendered; Generating an intermediate rendering according to the first original 3D information; Inputting the intermediate rendering into a generator set to generate a countermeasure neural network to obtain a 3D rendering.

Computer program codes for performing the operations of the present disclosure may be written in one or more programming languages or their combinations, including but not limited to object-oriented programming languages, such as Java, Smalltalk, C++, and conventional procedural programming languages, such as “C” language or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The units involved in the embodiment described in the present disclosure can be realized by software or hardware. Among them, the name of the unit does not constitute the limitation of the unit itself in some cases.

The functions described above herein may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of the present disclosure, a machine-readable medium may be a tangible medium that may contain or store a program for use by or in connection with an instruction execution system, device or apparatus. The machine-readable medium may be a machine-readable signal medium or a machine-readable storage medium. A machine-readable medium may include, but is not limited to, an electronic, magnetic, optical, electromagnetic, infrared, or semiconductor system, device or equipment, or any suitable combination of the above. More specific examples of the machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any suitable combination of the above.

According to one or more of the embodiments of the present disclosure, embodiments of the present disclosure provide an image processing method, comprising:
inputting an original image into a generator of a generative adversarial network to obtain an intermediate image and first pixel transformation information; and
performing pixel transformation on the intermediate image according to the first pixel transformation information to obtain a target image.

In one or more embodiments, the first pixel transformation information comprises at least one selected from the group consisting of optical flow transformation information, affine transformation information and perspective transformation information.

In one or more embodiments, the optical flow transformation information is represented by an optical flow transformation matrix, and each element in the optical flow transformation matrix characterizes a position offset between a pixel corresponding to the each element in the intermediate image and a pixel corresponding to the each element in the target image;
wherein the performing pixel transformation on the intermediate image according to the first pixel transformation information to obtain a target image comprises:
traversing elements of the optical flow transformation matrix, and according to the position offset of an element as traversed and current position information of a pixel corresponding to the element in the intermediate image, determining target position information of the pixel;
acquiring a current pixel value corresponding to the current position information and a target pixel value corresponding to the target position information in the intermediate image; and replacing the current pixel value with the target pixel value to obtain the target
image.

In one or more embodiments, the affine transformation information is a matrix with a first predetermined size,
wherein the performing pixel transformation on the intermediate image according to the first pixel transformation information to obtain a target image comprises:
for each pixel in the intermediate image, left-multiplying current position information of the pixel by the first pixel transformation information to obtain target position information of the pixel; and,
transferring pixel value of the pixel to a position corresponding to the target position information to obtain the target image.

In one or more embodiments, the perspective transformation information is a matrix with a second predetermined size,
wherein the performing pixel transformation on the intermediate image according to the first pixel transformation information to obtain a target image comprises:
for each pixel in the intermediate image, left-multiplying current position information of the pixel by the first pixel transformation information to obtain target position information of the pixel; and,
transferring pixel value of the pixel to a position corresponding to the target position information to obtain the target image.

In one or more embodiments, the generative adversarial network further comprises a discriminator; and the generative adversarial network is trained by:
acquiring an original image sample and a result image sample corresponding to the original image sample;
inputting the original image sample into the generator to obtain an intermediate image sample and second pixel transformation information;
performing pixel transformation on the intermediate image sample according to the second pixel transformation information to obtain a generated graph; and
performing alternating iterative training on the generator and the discriminator based on the generated graph, the original image sample and the result image sample.

In one or more embodiments, the performing alternating iterative training on the generator and the discriminator based on the generated graph, the original image sample and the result image sample comprises:
combining the generated graph and the original image sample into a negative sample pair, and combining the result image sample and the original image sample into a positive sample pair;
inputting the positive sample pair into the discriminator to obtain a first discriminant result, and inputting the negative sample pair into the discriminator to obtain a second discriminant result;
determining a first loss function based on the first discriminant result and the second discriminant result;
determining a second loss function according to the generated graph and the result image sample;
linearly superposing the first loss function and the second loss function to obtain a target loss function; and
performing alternating iterative training on the generator and the discriminator based on the target loss function.

In one or more embodiments, the generator comprises network layers and a pixel transformation module; the pixel transformation module is disposed between two network layers; a forward adjacent network layer of the pixel transformation module outputs a feature map and third pixel transformation information; the pixel transformation module is configured to perform pixel transformation on the feature map according to the third pixel transformation information and output a transformed feature map; and the transformed feature map is inputted to a backward adjacent network layer of the pixel transformation module.

1. An image processing method, comprising:
inputting an original image into a generator of a generative adversarial network to obtain an intermediate image and first pixel transformation information; and
performing pixel transformation on the intermediate image according to the first pixel transformation information to obtain a target image.

2. The method according to claim 1, wherein the first pixel transformation information comprises at least one selected from the group consisting of optical flow transformation information, affine transformation information and perspective transformation information.

3. The method according to claim 2, wherein the optical flow transformation information is represented by an optical flow transformation matrix, and each element in the optical flow transformation matrix characterizes a position offset between a pixel corresponding to the each element in the intermediate image and a pixel corresponding to the each element in the target image;
wherein the performing pixel transformation on the intermediate image according to the first pixel transformation information to obtain a target image comprises:
traversing elements of the optical flow transformation matrix, and according to the position offset of an element as traversed and current position information of a pixel corresponding to the element in the intermediate image, determining target position information of the pixel;
acquiring a current pixel value corresponding to the current position information and a target pixel value corresponding to the target position information in the intermediate image; and
replacing the current pixel value with the target pixel value to obtain the target image.

4. The method according to claim 2, wherein the affine transformation information is a matrix with a first predetermined size,
wherein the performing pixel transformation on the intermediate image according to the first pixel transformation information to obtain a target image comprises:
for each pixel in the intermediate image, left-multiplying current position information of the pixel by the first pixel transformation information to obtain target position information of the pixel; and,
transferring pixel value of the pixel to a position corresponding to the target position information to obtain the target image.

5. The method according to claim 2, wherein the perspective transformation information is a matrix with a second predetermined size,
wherein the performing pixel transformation on the intermediate image according to the first pixel transformation information to obtain a target image comprises:
for each pixel in the intermediate image, left-multiplying current position information of the pixel by the first pixel transformation information to obtain target position information of the pixel; and,
transferring pixel value of the pixel to a position corresponding to the target position information to obtain the target image.

6. The method according to claim 1, wherein the generative adversarial network further comprises a discriminator; and the generative adversarial network is trained by:
acquiring an original image sample and a result image sample corresponding to the original image sample;
inputting the original image sample into the generator to obtain an intermediate image sample and second pixel transformation information;
performing pixel transformation on the intermediate image sample according to the second pixel transformation information to obtain a generated graph; and
performing alternating iterative training on the generator and the discriminator based on the generated graph, the original image sample and the result image sample.

7. The method according to claim 6, wherein the performing alternating iterative training on the generator and the discriminator based on the generated graph, the original image sample and the result image sample comprises:
combining the generated graph and the original image sample into a negative sample pair, and combining the result image sample and the original image sample into a positive sample pair;
inputting the positive sample pair into the discriminator to obtain a first discriminant result, and inputting the negative sample pair into the discriminator to obtain a second discriminant result;
determining a first loss function based on the first discriminant result and the second discriminant result;
determining a second loss function according to the generated graph and the result image sample;
linearly superposing the first loss function and the second loss function to obtain a target loss function; and
performing alternating iterative training on the generator and the discriminator based on the target loss function.

8. The method according to claim 1, wherein the generator comprises network layers and a pixel transformation module; the pixel transformation module is disposed between two network layers; a forward adjacent network layer of the pixel transformation module outputs a feature map and third pixel transformation information; the pixel transformation module is configured to perform pixel transformation on the feature map according to the third pixel transformation information and output a transformed feature map; and the transformed feature map is inputted to a backward adjacent network layer of the pixel transformation module.

9. (canceled)

10. (canceled)

11. (canceled)

12. The method according to claim 1, wherein the original image is an image which includes a human face.

13. The method according to claim 1, wherein values of the first discriminant result and the second discriminant result are between 0 and 1, and configured to characterize the matching degree between sample pairs.

14. An image processing device, comprising:
a first pixel transformation information acquisition module configured to input an original image into a generator of a generative adversarial network to obtain an intermediate image and first pixel transformation information; and
a pixel transformation module configured to perform pixel transformation on the intermediate image according to the first pixel transformation information to obtain a target image.

15. An electronic apparatus, comprising:
at least one processing device; and
a storage apparatus configured to store at least one program,
the at least one program, when executed by the at least one processing device, causing the at least one processing device to input an original image into a generator of a generative adversarial network to obtain an intermediate image and first pixel transformation information; and perform pixel transformation on the intermediate image according to the first pixel transformation information to obtain a target image.

16. The electronic apparatus according to claim 15, wherein the first pixel transformation information comprises at least one selected from the group consisting of optical flow transformation information, affine transformation information and perspective transformation information.

17. The electronic apparatus according to claim 16, wherein the optical flow transformation information is represented by an optical flow transformation matrix, and each element in the optical flow transformation matrix characterizes a position offset between a pixel corresponding to the each element in the intermediate image and a pixel corresponding to the each element in the target image;
wherein the performing pixel transformation on the intermediate image according to the first pixel transformation information to obtain a target image comprises:
traversing elements of the optical flow transformation matrix, and according to the position offset of an element as traversed and current position information of a pixel corresponding to the element in the intermediate image, determining target position information of the pixel;
acquiring a current pixel value corresponding to the current position information and a target pixel value corresponding to the target position information in the intermediate image; and
replacing the current pixel value with the target pixel value to obtain the target image.

18. The electronic apparatus according to claim 16, wherein the affine transformation information is a matrix with a first predetermined size,
wherein the performing pixel transformation on the intermediate image according to the first pixel transformation information to obtain a target image comprises:
for each pixel in the intermediate image, left-multiplying current position information of the pixel by the first pixel transformation information to obtain target position information of the pixel; and,
transferring pixel value of the pixel to a position corresponding to the target position information to obtain the target image.

19. The electronic apparatus according to claim 16, wherein the perspective transformation information is a matrix with a second predetermined size,
wherein the performing pixel transformation on the intermediate image according to the first pixel transformation information to obtain a target image comprises:
for each pixel in the intermediate image, left-multiplying current position information of the pixel by the first pixel transformation information to obtain target position information of the pixel; and,
transferring pixel value of the pixel to a position corresponding to the target position information to obtain the target image.

20. The electronic apparatus according to claim 15, wherein the generative adversarial network further comprises a discriminator; and the generative adversarial network is trained by:
acquiring an original image sample and a result image sample corresponding to the original image sample;
inputting the original image sample into the generator to obtain an intermediate image sample and second pixel transformation information;
performing pixel transformation on the intermediate image sample according to the second pixel transformation information to obtain a generated graph; and
performing alternating iterative training on the generator and the discriminator based on the generated graph, the original image sample and the result image sample.

21. The electronic apparatus according to claim 20, wherein the performing alternating iterative training on the generator and the discriminator based on the generated graph, the original image sample and the result image sample comprises:
combining the generated graph and the original image sample into a negative sample pair, and combining the result image sample and the original image sample into a positive sample pair;
inputting the positive sample pair into the discriminator to obtain a first discriminant result, and inputting the negative sample pair into the discriminator to obtain a second discriminant result;
determining a first loss function based on the first discriminant result and the second discriminant result;
determining a second loss function according to the generated graph and the result image sample;
linearly superposing the first loss function and the second loss function to obtain a target loss function; and
performing alternating iterative training on the generator and the discriminator based on the target loss function.

22. The electronic apparatus according to claim 15, wherein the generator comprises network layers and a pixel transformation module; the pixel transformation module is disposed between two network layers; a forward adjacent network layer of the pixel transformation module outputs a feature map and third pixel transformation information; the pixel transformation module is configured to perform pixel transformation on the feature map according to the third pixel transformation information and output a transformed feature map; and the transformed feature map is inputted to a backward adjacent network layer of the pixel transformation module.

23. A computer-readable medium, on which a computer program is stored, wherein the computer program, when executed by a processing device, implements the image processing method according to claim 1.
